(19) United States
(12) Patent Application Publication
(10) Pub. No.: US 2012/0191725 A1
(43) Pub. Date: Jul. 26, 2012

(54) DOCUMENT RANKING SYSTEM WITH USER-DEFINED CONTINUOUS TERM WEIGHTING

(76) Inventors: Thomas M. Keeley, Brookfield, WI (US); Helena G. Keeley, Brookfield, WI (US); Victoria N. Loewengart, New Albany, OH (US)

(21) Appl. No.: 13/221,327

(22) Filed: Aug. 30, 2011

Related U.S. Application Data
(60) Provisional application No. 61/436,134, filed on Jan. 25, 2011.

(51) Int. Cl. G06F 17/30

(52) U.S. Cl. 707/748; 707/E17.084

(57) ABSTRACT

An information retrieval system allows the user to identifying not only search terms but also a weighting system for determining document relevance. The weighting systems may implement human-like weighting by the use of continuous curves whose features may be flexibly controlled by the user on the display screen providing interactive yet quantitative manipulation of the curves.

### CROSS REFERENCE TO RELATED APPLICATION

This application claims the benefit of U.S. provisional application 61/436,134 filed Jan. 25, 2011 and hereby incorporated by reference.

### STATEMENT REGARDING FEDERALLY SPONSORED RESEARCH OR DEVELOPMENT

Not applicable.

### BACKGROUND OF THE INVENTION

The present invention relates to information retrieval systems for identifying text or text-tagged documents, and in particular to an improved system for selecting and/or ranking document relevancy using sophisticated term weighting.

Gathering relevant information from large sets of text documents, particularly unstructured text documents, is critical for professional analysts. As one example, during the examination of applications for patents, existing patent documents that are most relevant to the invention of the application must be identified from over 7 million patent documents.

Common information retrieval search engines allow the user to construct a search query from search terms (such as words or phrases) combined in a regular expression (for example with conjunctions such as AND and OR or proximity limits). Often, the constructed query may also specify particular fields of the documents (e.g. specification, claims, inventor name, etc.) in which the search term must be located. More sophisticated information retrieval search engines may distinguish identical search terms with respect to term meaning (e.g. China as a country versus china as a ceramic product) using “text analytics” systems.

The success of information retrieval searches is highly dependent on the skill and insight of the searcher. An experienced searcher, for example, for patents, will select the appropriate search terms and search fields to avoid missing critical references while avoiding the return of large numbers of irrelevant references.

An important function of an information retrieval search engine is to rank the resulting documents so that the information retrieval system may be comprehensive, without obscuring the most relevant references in a sea of results. One example ranking method is the so-called “term frequency inverse document frequency” (TF-IDF) weighting system which applies weight to a document for the purpose of ranking that decreases the weight of search terms that occur very frequently in the collection of documents and increases the weight of terms that occur rarely. Such weighting systems can be highly sophisticated and mathematically complex and for this reason are normally built into the particular information retrieval tool.

### SUMMARY OF THE INVENTION

The present invention allows the skilled searcher to control the search process, beyond mere selection of search terms and search fields, by describing the weighting process that is normally internal to the retrieval search engine. As a general matter, the invention permits the searcher to flexibly yet precisely define the weighting of the search terms in a manner that mimics human-like judgment. In one embodiment, this weighting is defined by continuous weighting curves whose shape may be quantitatively set by the searcher, providing both an intuitive weighting and a numeric repeatability. A combination of these weights may employ a “diminishing return” algorithm to provide a combination of multiple factors that are mimicking that of human judgment.

Specifically, the present invention provides an information retrieval system that may receive from a searcher a set of search terms comprised of alphanumeric strings and weighting rules identified to particular search terms. The weighting rules provide a continuous weighting function relating search term frequency in a document to a search term weight for that search term for the document. Using this input, the information retrieval system reviews a set of documents with respect to the search terms and the rules identified to the search terms to provide a set of search term weights for each document; combines the search term weights for a document to produce a document weight; and outputs an indication of the documents and a ranking according to document weight.

It is thus a feature of at least one embodiment of the invention to permit greater control of the search process by the searcher without overwhelming the searcher with mathematical complexity typically associated with search ranking rules.

The weighting rules relating search term frequency to search term weight may have defining curves, and wherein the program accepts inputs from the user describing shapes of the curves.

It is thus a feature of at least one embodiment of the invention to provide a simple input mechanism that promotes a human-like selection judgment process.

The program may output a graphic display of the curves of the weighting rules changeable contemporaneously with user input.

It is thus a feature of at least one embodiment of the invention to provide a simple and intuitive user interface for describing complex weighting functions.

The inputs from the users are also displayed as quantitative values.

It is thus a feature of at least one embodiment of the invention to provide quantitative reproducibility to the weighting rules.

The inputs from the user may include inputs controlling at least one of a peak weight of the curve, and endpoint weight of the curve, left-hand slope of the curve, right-hand slope of the curve, left-hand midpoint weight of the curve, right-hand midpoint weight of the curve, and frequency position of the curve peak.

It is thus a feature of at least one embodiment of the invention to provide a limited set of controls that offer great flexibility in defining continuous weighting functions.

The inputs from the user may include starting curve shapes selected from the group consisting of an S-curve, a linear curve, a bell curve, and exponential curve, and a logarithmic curve.

It is thus a feature of at least one embodiment of the invention to provide a family of curves that are believed to be foundational models of human-like reasoning.

The program may include the step of saving the search terms and the weighting rules in a template file and the user input may include identifying a template file of predefined search terms and weights.

It is thus a feature of at least one embodiment of the invention to permit the construction and reuse of successful search weighting.

The program may further include the steps of permitting modification of search terms and weighting rules by further user input, as well as disabling and re-enabling search terms by further user input.

It is thus a feature of at least one embodiment of the invention to permit the preparation of standard templates that may be used as a starting point for general classes of searches.

The program may combine the search term weights to provide diminishing returns for each search term such that search terms with highest search weights contribute to the document weight less than the relative proportion of their search weight.

It is thus a feature of at least one embodiment of the invention to provide a both a weighting system and a method of combining weighted terms that reflects human-like judgment.

The computer program may further present a graphically displayed menu allowing selection of pre-stored search terms and/or pre-stored weighting rules by user input.

It is thus a feature of at least one embodiment of the invention to provide standard search terms commonly used in particular search situations.

The program may further accept input from the user designating the weighting rules as supporting or opposing, so that the weighting rules designated as supporting produce positive search term weights and the weighting rules designated as opposing produce negative search term weights.

It is thus a feature of at least one embodiment of the invention to provide both positive and negative weighting of search terms for greater search flexibility.

The program may further accept input from the user designating a type for the search term indicating at least one of: a sentiment associated with the search term, a concept name (for example an element type or a semantic tag) associated with the search term.

It is thus a feature of at least one embodiment of the invention to permit the invention to integrate with text analytics or sentiment analysis programs or the like.

These particular features and advantages may apply to only some embodiments falling within the claims and thus do not define the scope of the invention. The following description and figures illustrate a preferred embodiment of the invention. Such an embodiment does not necessarily represent the full scope of the invention, however. Furthermore, some embodiments may include only parts of a preferred embodiment. Therefore, reference must be made to the claims for interpreting the scope of the invention.

### BRIEF DESCRIPTION OF THE FIGURES

FIG. 1 is a block diagram of a computer system for executing the program of the present invention;

FIG. 2 is a display of an input screen provided by the present invention allowing entry of user defined search terms and user-defined weighting rules;

FIG. 3 is a display of an input screen provided to the user allowing entry of continuous functions implementing the user-defined weighting rules;

FIG. 4 is a block diagram of principal functional elements of one embodiment of the invention showing the routing of the user-defined search terms and user-defined weighting rules to different functional blocks;

FIG. 5 is a flowchart of the operation of the present invention; and

FIG. 6 is a display of the output screen showing the results of the present invention as linked to underlying text documents.

### DETAILED DESCRIPTION OF THE PREFERRED EMBODIMENT

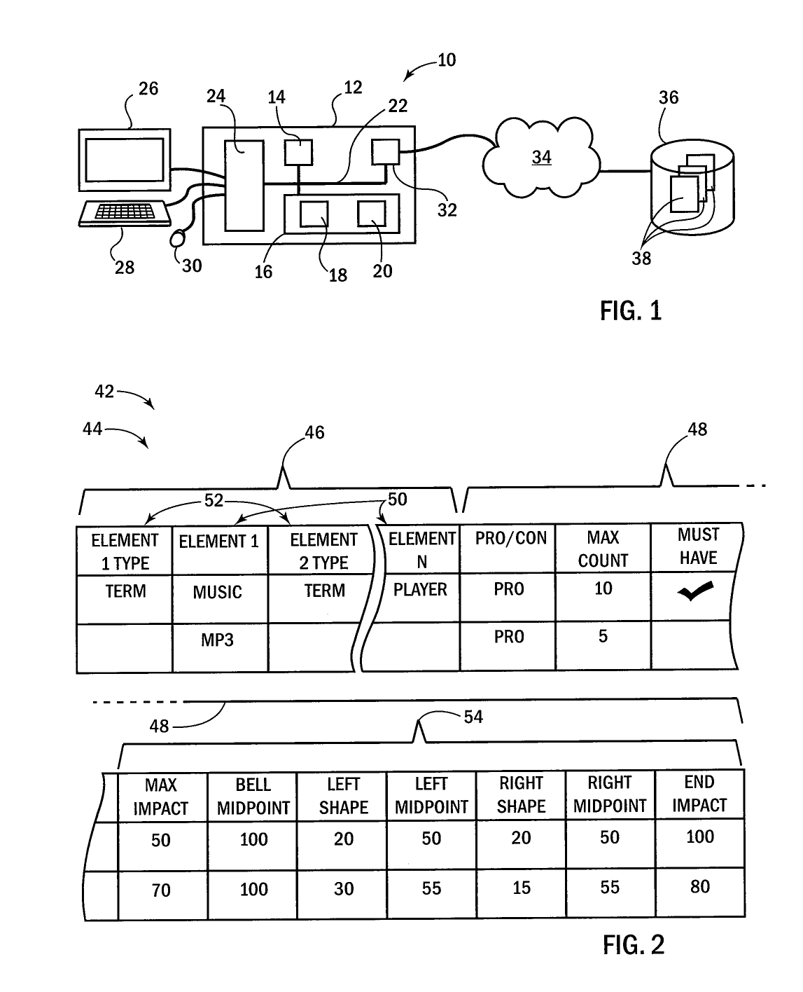

Referring now to FIG. 1, a computer system 10 for implementing the present invention may provide for a processor system 12 having a processor 14 communicating with a memory 16 holding an operating system 18 and a program 20 implementing all or portions of the present invention.

The processor 14 and memory 16 may inter-communicate on a bus 22 also communicating with an interface 24 that may connect to a display screen 26 for providing output to a user and that may further connect to input devices such as a keyboard 28 and cursor control device 30 for receiving input from the user, all of types well known in the art.

A network connection 32 may allow connection through, for example, the Internet 34 to document repository 36 containing multiple structured and unstructured text documents 38 that may be the subject of an information retrieval search. For example, the documents 38 may be patent documents held by the US Patent and Trademark Office.

Referring now to FIGS. 2 and 5, at a first step of program 20, indicated by process block 40, the program 20 may receive, from the user, user-defined search terms through a parameter entry chart 44 presented on display screen 42 as shown in FIG. 2. In one embodiment, the parameter entry chart 44 may provide a defined search term 46 described by parameters of multiple columns, and an associated weighting rule 48 defined by parameters in multiple columns, each column as may receive data from the user, for example, as typed on the keyboard 28 (FIG. 1).

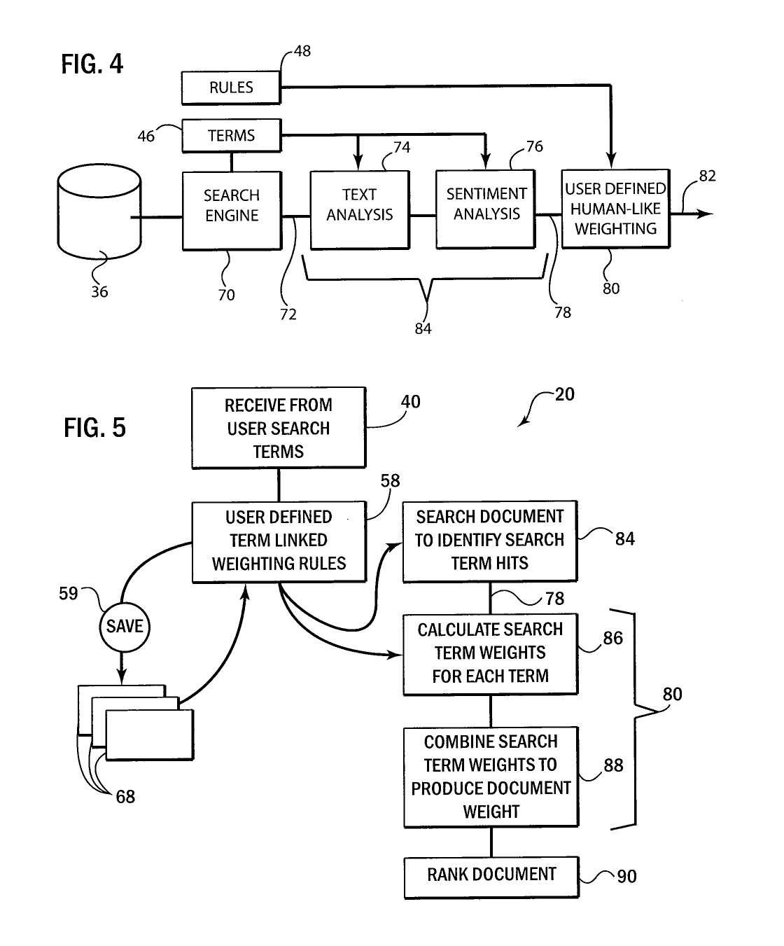

The search terms 46 (FIG. 4) may be generally defined as in terms of constituent text elements 50, for example, being short alphanumeric strings such as words or phrases, coupled to element characterizations 52, for example, including element types or sentiment. Alphanumeric characters should be understood to include Unicode Universal character set Transformation Formats (UTF) encoding. Element types as used herein describe contextual understandings of the elements, for example, whether they are names of persons or companies or disambiguations of the type that may be provided by text analytics engines, as will be described below. This characterization of the element types may be obtained from commercially available products and may operate, for example, by tagging returned search terms as will be described. Sentiment indicates an inferred attitude of the author of the text document in which the search terms are found and whether the inferred attitude tends to reflect positively or negatively on the associated text in the document. The sentiment may be positive or negative and obtained by analyzing the document against a specially prepared dictionary where words, for example, such as “unacceptable” denote negative sentiment and words such as “excellent” represent positive sentiment.

Referring again to FIG. 5, at a next process block 58, weighting rules 48 may be entered. Generally, when the search terms 46 provide for multiple text elements 50 each element is given the same weighting rule 48 shown on the same row. The weighting rules 48 have a number of parameters including “pro/con” indicating whether the weighting is additive or subtractive (i.e., “pro” or “con”) that is tending to support or oppose the relevance of the particular document. Supporting search terms provide for positive weights in the weighting process to be described below, whereas opposing search terms provide for negative weights in the weighting process.

A “maximum count” parameter may be provided indicating the number of occurrences of the search term in the document after which no more weight is provided by additional search terms. A “must have” parameter indicates whether the search term must be found in the document for the document to be included in the ultimate results.

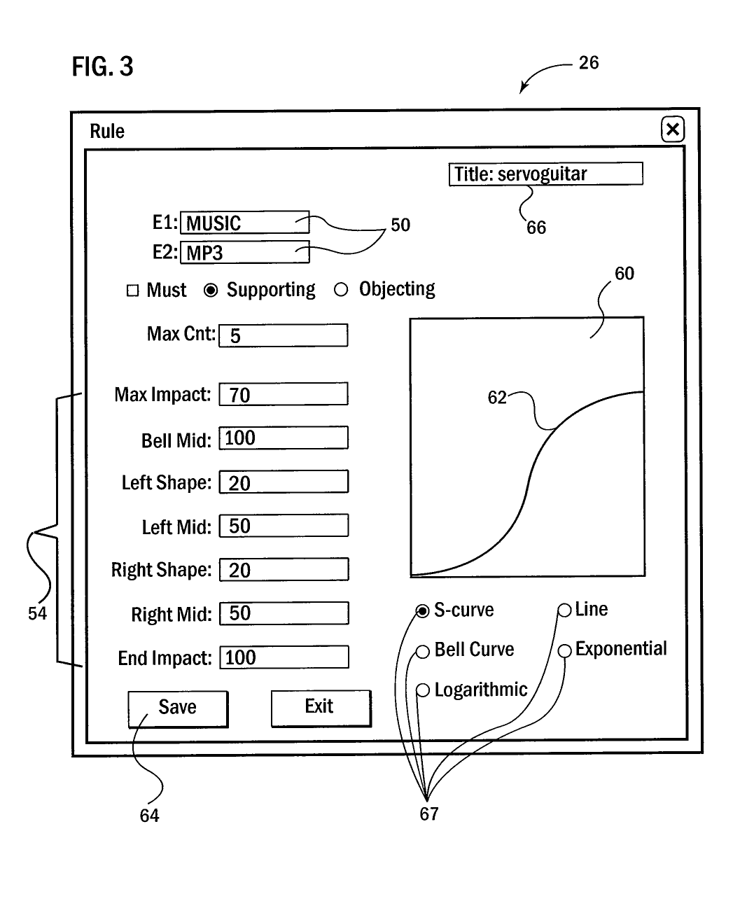

The remaining parameters of the weighting rules 48 are functional definition 54 of a continuous function defining a human-like weight particular search term 46 as a function of the number of times the search term 46 is found in a document. Referring now also to FIG. 3, this function may be characterized by seven numeric parameters which may be directly entered into the parameter entry chart 44 of the display screen 42 or which may be entered on a function definition screen of FIG. 3 interactively while viewing a graphical display 60 of a curve 62 representing the function on display screen 26. The curve 62 plots search term frequency on the horizontal axis up to the maximum count value against a functional search term weight normalized for example from 0 to 100. The display screen 26 may also display of the text elements 50 and of the values of the components “pro/con”, “must have”, and “max count” for operator convenience.

Generally each of the parameters of the functional definition 54 provide intuitive human understandable definitions of a more complex mathematical description of the curve 62. In creating this curve 62, the user may select one of a set of predetermined starting point choices 67, for example, providing for an S-curve (as shown ends smoothly transitioning between a zero slope, a positive slope, and a zero slope), a bell curve (approximating a Gaussian function centered within the graphical display 60) a line curve (being a straight line of approximately 45° from the lower left to the upper right of the area of the graphical display 60), an exponential curve (rising exponentially in the area of the graphical display 60) or logarithmic curve (rising asymptotically to a logarithmic asymptote). Each of these curves will automatically populate the seven parameters of the functional definition 54 with quantitative values that characterize the curves and which may be noted and/or changed by the user. Importantly each of these curves provides for continuous weighting function that reflects functions associated with human-like reasoning.

The parameters of the functional definition 54 may include “maximum impact” which provides the maximum height of the curve 62 (here shown as normalized to a maximum value of 100). A parameter of “bell midpoint” defines where on the horizontal axis the highest point of the curve will occur. The parameter “left shape” and “right shape” provide slope values of the left and right of the curve, whereas the values of “left midpoint” and “right midpoint” defined the weight value midpoints of the left and right side of the curve with respect to its maximum impact value. The “end impact” feature describes the height of the end of the curve 62 with respect to the maximum impact value. Other methods of defining these curve features may be provided but importantly each of these parameters is quantifiable and therefore reproducible.

Referring now to FIGS. 2, 3 and 5, the user may activate a save button 64 to cause a saving 59 of the parameters of the search terms 46 and weighting rules 48 in a template file 68 with the given name entered by the user in a title text box 66. This allows carefully constructed search terms to be used as a starting point for constructing a new search or without change for efficient future searching.

The present invention also contemplates that the template file 68 may be pre-populated with templates having standardized search terms 46 and weighting rules 48, whose access may be obtained by the user through a drop-down menu or the like either as a starting point for future editing or for use as is.

Referring now to FIG. 4, the search terms 46 collected as described above will normally be applied to a standard search engine 70, for example, the USPTO patent search database accessible at www.uspto.gov. The results of this search, using the search terms 46 (and implicitly subject to an internal weighting system of the search engine 70) provide of a set of text document 72. Alternatively, when direct access is available to the document repository 36, the invention may work directly on the set of text documents in the document repository 36.

The set of text documents 72 or the original documents of the document repository 36 may be optionally passed to a text analytics engine 74 and a sentiment analysis engine 76 which receive the search terms 46, qualified by characterizations 52, and characterized each document according to the number of “hits” 78 of the search terms 46 as amplified. Thus, for example, if a search term of “China” is characterized as the country, the text analytics engine 74 will signal hits 78 only when China is mentioned as a country. Likewise if the search term “customer reaction” is characterized as requiring a positive sentiment, a hit will be developed by the sentiment analysis engine 76 only if the sentiment of the document is positive.

The resulting hits 78 for each search term for each document are then provided to weighting block 80 which applies the weighting rules 48 developed by the user for each search term 46 to provide a set of document ranking values 82.

Referring to FIGS. 4 and 5, this operation of function blocks 70, 74 and 76 (or 74 and 76 integrated into a freestanding search engine) is indicated by process block 84 which analyzes each document for hits 78. The function of the weighting block 80 is implemented by process block 86, 88 and 90 as follows. At process block 86, the number of hits 78 for each search term is applied to the weighting rules 48 in particular to the functions defined by the curves 62 for those weighting rules 48. At process block 88, the resulting weights for each search term are combined according to a diminishing return calculation, which decreases the influence of search terms that would otherwise dominate the document weight and is described in the Example below. This diminishing returns calculation, in one embodiment, provides the same value independent of the ordering of the terms. Finally, at process block 90, the documents are ranked according to their cumulative weighting scores and presented to the user.

### Example I

An example of determining a document weight using the above described user inputs may produce a document weight normalized to between zero and 100. For each document, the search term or group of search terms is counted to produce a Count (C). This count may be divided by the Max Count value (MC) and multiplied by 100 with a maximum result of 100 if the Count exceeds the Max Count to provide a “Count value”.

This “Count value” is then used to find a point on the curve 62 defined by the user to yield a “Rule value”. The rule can either be supporting or objecting. The supporting and objecting rule values are stored in two arrays: The “sup” array contains the values of the supporting rules, “supcnt” long (the number of supporting rules). The “obj” array contains the values of the objecting rules, “objcnt” long (the number of objecting rules).

The accumulation of rules to determine a document ranking value is accomplished as follows where “docvalue” ends up with the final ranking document value:

//initialize docvalue
docvalue=0;
//Accumulate support using law of diminishing returns
//where first supporting rule carries more weight than second
//and second carries more weight than third...
for (i=0;i<supcnt;i++){

docvalue=docvalue+((100−docvalue)*sup[i])/100;

}
//Detract from accumulated document value with objecting rules
//using law of diminishing returns
//where the first objecting rule carries more weight than second
//and the second carries more weight than third...
for (i=0;i<objcnt;i++){

docvalue=docvalue−((docvalue*obj[i])/100);

}
//docvalue has the final document value

Other means of accumulating supporting and objecting reasons could also be used. Importantly the user configured curves 62 describe how to interpret the count of terms for each rule.

between +100 (fully positive) to −100 (fully negative) Formula for sentiment value

This is accomplished by accumulating all the positive terms and subtracting the accumulation of all the negative terms.

//initialize the positive value
posval=0;
//Accumulate positive sentiment using law of diminishing returns
//where first positive rule carries more weight than second
//and second carries more weight than third...
for (i=0;i<supcnt;i++){

posvalue=posvalue+((100−posvalue)*sup[i])/100;

}
//initialize the negative value
negval=0;
//Accumulate negative sentiment using law of diminishing returns
//where first negative rule carries more weight than second
//and second carries more weight than third...
for (i=0;i<objcnt;i++){

negvalue=negvalue+((100−negvalue)*obj[i])/100;

}
//subtract the negative accumulation
//from the positive accumulation
sentimentvalue=posvalue−negvalue;

Importantly, user configured curves describe how to interpret the count of positive and negative terms for each rule.

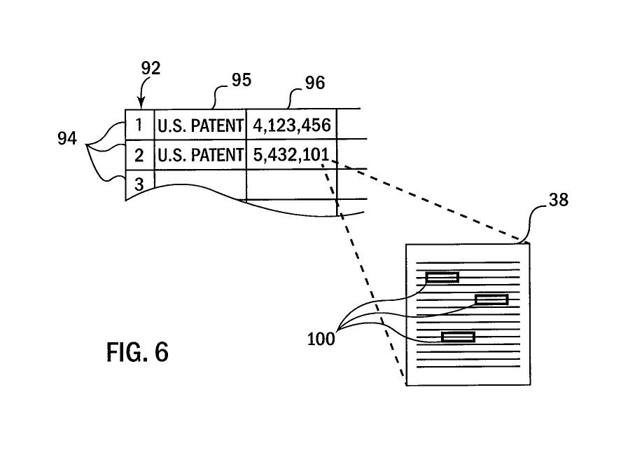

Referring now to FIG. 6, the ranked outputs may, for example, may be displayed to the user as a table 92 as a set of rows each having a ranking number 94 indicating a ranking of the document according to the combined weighting described above, a text string 95 identifying the document type, and a unique document identifier 96 (in this example the US patent document number). The identifiers 96 may be linked to the underlying documents 38 which may have highlighted search terms 100.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a controller” and “a processor” can be understood to include one or more controllers or processors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

We claim:

1. An information retrieval system comprising a program stored in a non-transient medium and executable on an electronic computer to:
(a) receive from a user a set of search terms comprised of alphanumeric strings,
(b) receive from the user weighting rules identified to particular search terms wherein the weighting rules provide a continuous weighting function relating search term frequency in a document to a search term weight for that that search term for the document;
(c) review a set of documents with respect to the search terms and the rules identified to the search terms to provide a set of search term weights for each document
(d) combine the search term weights for document to produce a document weight; and
(e) output an indication of the documents and a ranking according to document weight.

2. The program of claim 1 wherein the weighting rules relating search term frequency to search term weight have defining curves, and wherein the program accepts inputs from the user describing shapes of the curves.

3. The program of claim 2 wherein the program further outputs a graphic display of the curves of the weighting rules changeable contemporaneously with user input.

4. The program of claim 3 wherein the inputs from the user are also displayed as quantitative values.

5. The program of claim 3 wherein the inputs from the user users include inputs controlling at least one of a peak weight of the curve, and endpoint weight of the curve, left-hand slope of the curve, right-hand slope of the curve, left-hand midpoint weight of the curve, right-hand midpoint weight of the curve, and frequency position of the curve peak.

6. The program of claim 3 wherein the inputs from the user include starting curve shapes selected from the group consisting of an S-curve, a linear curve, a bell curve, and exponential curve, and a logarithmic curve.

7. The program of claim 1 wherein the program further includes the step of saving the search terms and the weighting rules in a template file and wherein step (b) they include identifying a template file of predefined search terms and weights.

8. The program of claim 7 wherein the program further includes the steps of permitting modification of search terms and weighting rules, as well as disabling or re-enabling rules by further user input.

9. The program of claim 1 wherein step (d) combines the search term weights so as to provide diminishing returns for each search term such that search terms with highest search weights contribute to the document weight less than a relative proportion of their search weight.

10. The program of claim 1 wherein the program further presents a graphically displayed menu allowing selection of pre-stored search terms by user input.

11. The program of claim 1 wherein the program further presents menu items allowing selection of pre-stored weighting rules by user input.

12. The program of claim 1 wherein the program may further accept input from the user designating the weighting rules as supporting or opposing, so that the weighting rules designated as supporting produce positive search term weights and the weighting rules designated as opposing produce negative search term weights.

13. The program of claim 1 wherein the program may further accept input from the user designating a type for the search term indicating at least one of: a sentiment associated with the search term, a concept associated with the search term.

14. A method of information retrieval system comprising the steps of:
(a) receive from a user a set of search terms comprised of alphanumeric strings;
(b) receive from the user weighting rules identified to particular search terms wherein the weighting rules provide a continuous weighting function relating search term frequency in a document to a search term weight for that that search term for the document;
(c) review a set of documents with respect to the search terms and the rules identified to the search terms to provide a set of search term weights for each document
(d) combine the search term weights for document to produce a document weight; and
(e) output an indication of the documents and a ranking according to document weight.

15. The method of claim 14 wherein the weighting rules relating search term frequency to search term weight have defining curves, and including the step of accepting inputs from the user describing shapes of the curves.

16. The method of claim 15 further including the step of outputting a graphic display of the curves of the weighting rules changeable contemporaneously with user input.

17. The method of claim 15 further including the step of outputting the inputs from the user as quantitative values.

18. The method of claim 15 wherein the inputs from the user include inputs controlling at least one of a peak weight of the curve, an endpoint weight of the curve, left-hand slope of the curve, right-hand slope of the curve, left-hand midpoint weight of the curve, right-hand midpoint weight of the curve, and frequency position of the curve peak.

19. The method of claim 15 wherein the inputs from the user include starting curve shapes selected from the group consisting of a S-curve, a linear curve, a bell curve, an exponential curve, and a logarithmic curve.

20. The method of claim 14 including the step of saving the search terms and the weighting rules in a template file and wherein step (b) they include identifying a template file of predefined search terms and weights.

21. The method of claim 14 wherein step (d) combines the search term weights so as to provide diminishing returns for each search term such that search terms with highest search weights contribute to the document weight less than a relative proportion of their search weight.
